(19) United States
(12) Patent Application Publication
(10) Pub. No.: US 2004/0081024 A1
(43) Pub. Date: Apr. 29, 2004

(54) Wristwatch with functions of basal body temperature charting and ovulation phase informing

(76) Inventor: Yuan Sung Weng, Taipei (TW)

Correspondence Address: BUCKNAM AND ARCHER, 1077 NORTHERN BOULEVARD, ROSLYN, NY, 11576, US

(21) Appl. No.: 10/641,499

(22) Filed: Aug. 15, 2003

(30) Foreign Application Priority Data
Oct. 23, 2002 (TW) 091216947

(51) Int. Cl. G04B 47/00

(52) U.S. Cl. 368/10

(57) ABSTRACT

The present invention relates to a wristwatch with functions of basal body temperature (BBT) charting and ovulation phase informing, comprising: a case, for demarcating an space with a control circuit unit accommodated therein; a display unit; a memory cell; a timer unit; a battery; and a sensor unit containing a temperature sensor and a computing device for taking the basal body temperature of a female so as to inform her with predicted ovulation phase.

### BACKGROUND OF THE INVENTION

1. Field of the Invention

The present invention relates to a wristwatch with functions of basal body temperature charting and ovulation phase informing, especially to a wristwatch capable of performing automatic basal body temperature charting of a female user and predicting the ovulation phase base on such chart and a pre-stored data of menstrual cycle.

2. Description of the Prior Art

In general, female usually predict her ovulation phase base on two methods, i.e. BBT (Basal Body Temperature) charting and menstrual cycle evaluation. In order to better understand the principle of present invention, brief description of both methods is given below:

1. Method of BBT Charting

In 1904, Dutch obstetrician Van de Velde (1873-1937) has pointed out that female's body temperature indicates her physiological variation. During his days, people have not yet clearly understood the relation among menses, ovulation, endocrine, and fertility; therefore have no idea about the correlation between female's body temperature and fertility. Not until 1943, no one have ever observed a lower body temperature during the follicular phase, up to about 14 days before the next menses a sustained rise in temperature of about 0.5° C. during the luteal phase, and normal temperature afterward. Only days after the third day of temperature rise and before next menses are considered as safe infertility phase. With this method, a specific thermometer must be used starting from the first day of menses at fixed wakeup time before any activity to record a detailed chart of basal body temperature.

2. Method of Menstrual Cycle Evaluation

In 1930, Japanese obstetrician Ogino (1882-1974) has pointed out that one should not predict the fertilization time of an ovum base on the previous menses but next menses. He also pointed out that the fertilization time of an ovum varies in accordance with the menstrual cycle, i.e., the period between current ovulation phase and the first day of next menses is fixed, however, the period between the first day of current menses and the ovulation phase may vary. Ogino concluded that the ovulation phase fall between the twelfth to the sixteenth day before next menses. However, it does not mean that other than these days will be safe infertility phase due to sperms may survive inside female's genital organ for days after intercourse and during such period it is still possible to cause fertility. Therefore, Ogino defined the ovulation phase as the tenth to the seventeenth days before next menses, while the safe infertility phase as from the first to ninth days of current menses and between the eighteenth day of current menses and the first day of next menses, provided a menstrual cycle of 28 days. To apply the method of menstrual cycle evaluation, one must have regular menstrual cycle and after at least 6 consecutive months' record of menstrual cycle in order to make optimized prediction base on the longest and the shortest menstrual cycle.

As described above, one of the method requires the record of previous menstrual cycle and at least 6 consecutive months' record of menstrual cycle and the other method needs to take daily basal body temperature in order to predict the ovulation phase. However, this is troublesome in that one should always remember to trace the menstrual cycle and keep the chart handy to make the ovulation phase prediction. Therefore, it is necessary to develop a device to allow that one can easily predict the ovulation phase base on the menstrual cycle, basal body temperature charting, and long-term recording without the inconvenience result from lack of precise record tracing.

### SUMMARY OF THE INVENTION

Therefore, an object of present invention is to provide a wristwatch with functions of basal body temperature (BBT) charting and ovulation phase informing so as to predict the ovulation phase base on automatically recorded BBT chart and the input of previous menstrual cycle.

To achieve the above object, in one aspect of present invention there is provided a wristwatch with functions of timing, basal body temperature (BBT) charting and ovulation phase informing, comprising: a case, for demarcating an space; a control circuit unit accommodated inside the space of said case; a display unit, for displaying time and data; a memory cell, for storing data; an input unit, for date recording; a timer unit, for providing time used in recording; a battery, for supplying work voltage to each members; and a sensor unit containing a temperature sensor and a computing device for predicting ovulation phase base on the so called method of triple evaluation.

In another aspect of present invention, the display unit is a liquid crystal display.

In further aspect of present invention, the input date is the menstrual cycle.

In still another aspect of present invention, the data includes the predicted ovulation phase and safe infertility phase.

In yet another aspect of present invention, the wristwatch further comprises an alarm for reminding on with the infertility phase.

In still yet another aspect of present invention, said method of triple evaluation works base on the menstrual cycle, basal body temperature charting, and long-term recording.

### BRIEF DESCRIPTION OF DRAWINGS

The above and other objects, features, and advantages of present invention will become more apparent from the detailed description in conjunction with the accompanying drawings:

FIG. 1 is a block diagram schematically showing the structure of a wristwatch with functions of basal body temperature (BBT) charting and ovulation phase informing in accordance with a preferred embodiment of present invention.

FIGS. 2A and 2B are top and bottom views showing a product made in accordance with the preferred embodiment of present invention, respectively.

FIG. 3 is a flow chart showing the operation process of the preferred embodiment of present invention.

### DETAILED DESCRIPTION OF THE INVENTION

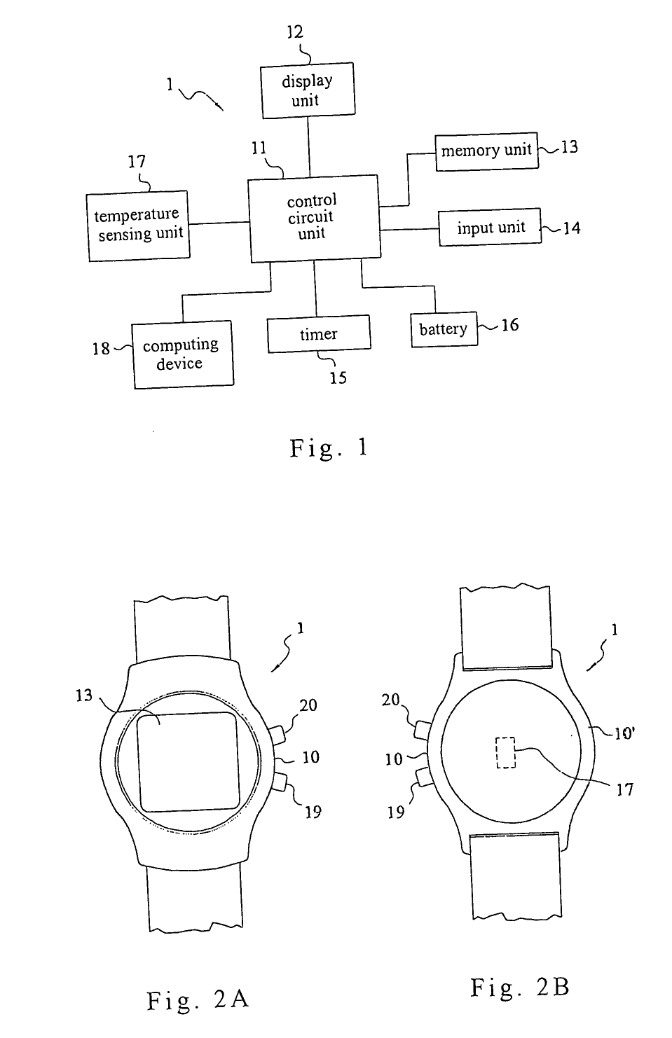

Referred to FIG. 1 and FIG. 2, FIG. 1 is a block diagram schematically showing the structure of a wristwatch 1 with functions of basal body temperature (BBT) charting and ovulation phase informing in accordance with a preferred embodiment of present invention; FIGS. 2A and 2B are top and bottom views showing a product made in accordance with the preferred embodiment of present invention, respectively.

The wristwatch 1 comprises: a case 10, for demarcating an space with a control circuit unit 11 accommodated therein; a display unit 12; a memory cell 13; an input unit 14; a timer unit 15; a battery 16; and a sensor unit containing a temperature sensor 17 and a computing device 18.

As shown in the figure, said control circuit unit 11 manages and controls the operation of each member in the wristwatch 1. The display unit 12 is a liquid crystal display used for displaying time and data, in which a select key 19 is used to control data displaying through the display unit 12. The memory unit 13 stores data such as the predicted ovulation phase and safe infertility phase acquired in a manner described later. The input unit 14 inputs a control signal entered by user through a control key 20 and pre-stored data, which can be entered by the first time user through a select key 19, to the control circuit unit 11 and the control circuit unit 11 will then control the data displaying base on those input. The timer unit 15 displays time on said display unit 12 through said control circuit unit 11. The battery 16 supplies work voltage to each members so as to conduct corresponding operation.

The sensor unit comprises: a temperature sensor 17, attached to the inner surface of the metal base cover 10′ of the wristwatch 1, for regularly sensing the body temperature through contact with user's wrist and storing sensed body temperature in the memory unit 13 through the control circuit unit 11; and a computing device 18, for predicting the ovulation phase base on the menstrual cycle, basal body temperature charting, and long-term recording and displaying an alerting message on the display unit 12 while warning the user through a beeper (not shown) about the ovulation phase prediction.

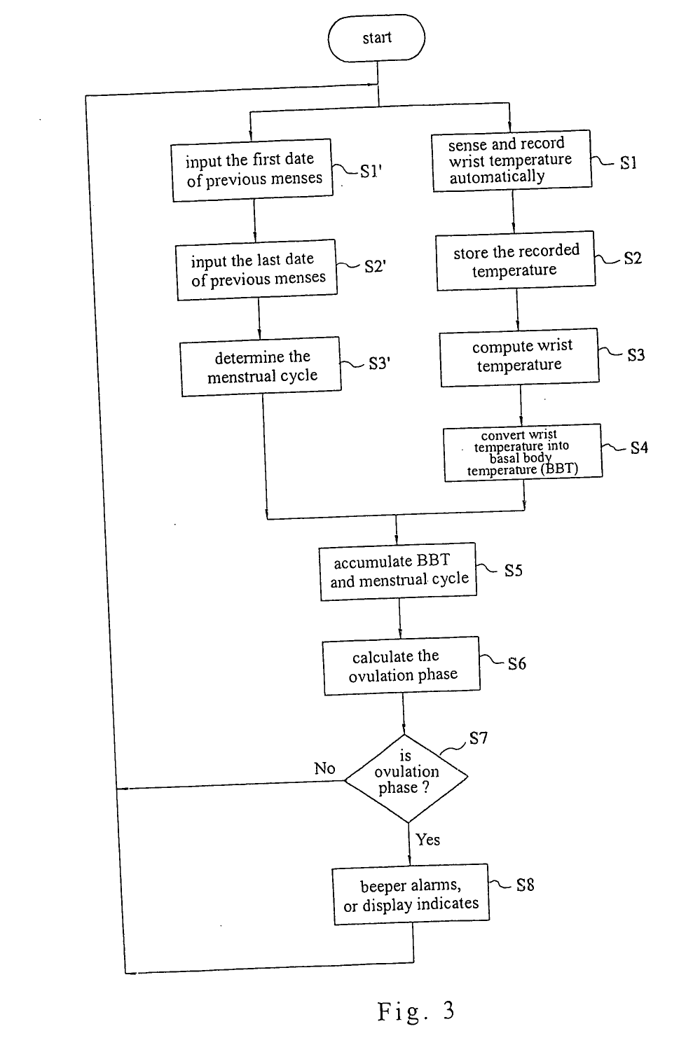

FIG. 3 is a flow chart showing the operation process of the preferred embodiment of present invention. First, the wristwatch 1 regularly records wrist temperature through the temperature sensor 17 in step S1 and stores recorded basal body temperature in the memory unit 13 in step S2. In steps S3 and S4, the computing device 18 converts the wrist temperature into the basal body temperature. In step S1′ and S2′, user can input the date of the first day and the last day of previous menses. In step S3′, said computing device 18 determines the menstrual cycle base on said input dates, and the process moves to step S5. In step S5, by accumulating the basal body temperature acquired in steps S1 to S4 and the menstrual cycle and the long-term recording acquired in steps S1′ to S3′, the computing device 18 predicts the ovulation phase by means of the method of triple evaluation in steps S6 and S7 and provides beeping sound or alerting message on said display unit 12 (step S8) as needed.

As described above, the wristwatch in accordance with the present invention, provides convenient functions of basal body temperature (BBT) charting and ovulation phase informing without any troublesome precise record tracing.

However, above described is a preferred embodiment of present invention. Those who are skilled in the prior should recognize that present invention is not limited to above description, and various modifications and changes in accordance with claims given below are considered to fall within the spirit and scope of present invention.

### List of Reference Numerals

Numeral Elements

1 wristwatch

10 case

10′ metal base cover

11 control circuit unit

12 display unit

13 memory cell

14 input unit

15 timer

16 battery

17 temperature sensing unit

18 computing device

19 select key

20 control key

What is claimed is:

1. A wristwatch with functions of timing, basal body temperature (BBT) charting and ovulation phase informing, comprising a case, for demarcating an space with the following members accommodated therein:
a control circuit unit, manages and controls the operation of each member in the wristwatch 1;
a display unit, for displaying time and data;
a memory cell, for storing data;
an input unit, for date recording;
a timer unit, for providing time used in recording;
a battery, for supplying work voltage to each members; and
a sensor unit containing a temperature sensor and a computing device for predicting ovulation phase base on the so called method of triple evaluation.

2. The wristwatch as set forth in claim 1, in which said display unit is a liquid crystal display.

3. The wristwatch as set forth in claim 1, in which said input date is the menstrual cycle.

4. The wristwatch as set forth in claim 1, in which said data includes the predicted ovulation phase and safe infertility phase.

5. The wristwatch as set forth in claim 1, in which said wristwatch further comprises a beeper for reminding on with the infertility phase.

6. The wristwatch as set forth in claim 1, in which said method of triple evaluation works base on the menstrual cycle, basal body temperature charting, and long-term recording.
